(19) United States
(12) Patent Application Publication
(10) Pub. No.: US 2011/0025838 A1
(43) Pub. Date: Feb. 3, 2011

(54) METHOD AND APPARATUS FOR INSPECTING DEFECTS IN WAFER

(75) Inventor: Masaharu NINOMIYA, Saga (JP)

Correspondence Address: GREENBLUM & BERNSTEIN, P.L.C., 1950 ROLAND CLARKE PLACE, RESTON, VA, 20191, US

(73) Assignee: SUMCO CORPORATION, Tokyo (JP)

(21) Appl. No.: 12/839,499

(22) Filed: Jul. 20, 2010

(30) Foreign Application Priority Data
Jul. 31, 2009 (JP) 2009-179251

(51) Int. Cl. H04N 7/18; G06K 9/00

(52) U.S. Cl. 348/87; 382/149; 348/E07.085; 348/E05.09

(57) ABSTRACT

An object of the present invention is to simplify the defect inspection of an internal defect and front and rear surface defects in a wafer. A defect inspection method of the present invention includes: a first imaging step of taking a transmitted image of a wafer 1 by disposing two light source/image pickup units 4 and 5 equipped with a light source, an image pickup device and an optical system oppositely to each other across the wafer 1, irradiating infrared light from at least one of the light source/image pickup units 4 and 5 to the wafer 1, and receiving transmitted light from the wafer 1; a second imaging step of taking the respective reflected images of both wafer surfaces by irradiating infrared light or visible light from the light source/image pickup units 4 and 5 to the wafer 1 and receiving reflected light from the wafer 1; and an extraction step of extracting the defects in the wafer 1 on the basis of the transmitted image and the reflected images of both surfaces, thereby simultaneously detecting both an internal defect and front and rear surface defects in the wafer.

### BACKGROUND OF THE INVENTION

1. Field of the Invention

The present invention relates to a method and an apparatus for inspecting defects in a wafer, and more particularly, to a technique for inspecting internal defects and front and rear surface defects in the wafer by using transmitted images obtained by irradiating infrared light to the wafer.

2. Description of the Related Art

For example, a technique for inspecting internal defects in a wafer is described in JP2006-351669A. According to this technique, infrared light is irradiated from one surface of a wafer and infrared light having transmitted through the wafer is received by an infrared camera disposed at the other surface of the wafer. Then, the wafer is inspected for internal defects on the basis of a transmitted image obtained by the transmitted infrared light. That is, if any defects, such as voids or cracks, exist within the wafer, the irradiated infrared light is scattered by the defects within the wafer. For this reason, the defects appear in the transmitted image as dark portions. The patent document states that consequently, it is possible to inspect the wafer for internal defects by observing the transmitted image of the wafer.

On the other hand, a technique for inspecting surface defects in a wafer is proposed in JP2002-122552A. According to this technique, a light source/image pickup unit equipped with a light source, an image pickup device and an optical system is disposed at one surface of the wafer. Laser light is irradiated from the light source/image pickup unit to the wafer to take a reflected image of the wafer. Then, the wafer is inspected for defects in a wafer surface on the basis of the reflected image.

However, no consideration is given in JP2006-351669A and JP2002-122552A with regard to the simultaneous detection of internal defects and front and rear surface defects in a wafer. For example, in order to inspect internal defects and front and rear surface defects in the wafer by combining the techniques of JP2006-351669A and JP2002-122552A, a light source/image pickup unit for taking transmitted images and a light source/image pickup unit for taking reflected images need to be arranged separately. Then, after the completion of inspection based on one light source/image pickup unit, the wafer and the light source/image pickup unit need to be moved. Thus, it is not possible to inspect both types of defects at the same time. In addition, in order to detect front and rear surface defects in the wafer by using the technique described in JP2002-122552A, it is necessary to flip over the wafer or move the light source/image pickup unit to the other surface of the wafer after taking a transmitted image of one surface of the wafer. This means that it is not possible for the related arts to simultaneously inspect both internal defects and front and rear surface defects in the wafer. Accordingly, extra time and effort is involved in implementing defect inspection, thus causing the problem of degradation in the work efficiency of defect inspection.

An object of the present invention is to simultaneously detect both internal defects and front and rear surface defects in a wafer and improve work efficiency in defect inspection.

### SUMMARY OF THE INVENTION

In order to achieve the aforementioned object, a method for inspecting defects in a wafer according to the present invention irradiates light to a wafer to take at least one of a transmitted image and a reflected image of the wafer, and image-processes the taken image to inspect defects in the wafer, including internal defects.

A first aspect of the method for inspecting defects in a wafer according to the present invention includes: a first imaging step of taking a transmitted image of a wafer by disposing two light source/image pickup units equipped with a light source, an image pickup device and an optical system oppositely to each other across the wafer, irradiating infrared light from at least one of the light source/image pickup units to the wafer, and receiving transmitted light from the wafer with the other light source/image pickup unit; and a second imaging step of taking the respective reflected images of both surfaces of the wafer by irradiating infrared light or visible light from the light source/image pickup units to the wafer and receiving reflected light from the wafer with the light source/image pickup units, thereby inspecting defects in the wafer by means of image processing including an extraction step of extracting the defects in the wafer on the basis of the transmitted image and the reflected images of both surfaces of the wafer.

According to this method, since the two light source/image pickup units are disposed oppositely to each other across the wafer, it is possible to simultaneously take both the transmitted image of the wafer and the reflected images of the front and rear surfaces of the wafer. Consequently, it is possible to simultaneously detect both internal defects and front and rear surface defects in the wafer. In addition, since the light source/image pickup units for taking the transmitted image of the wafer and the reflected images of both surfaces of the wafer are adapted for common use to reduce time and effort involved in defect inspection, it is possible to improve work efficiency in the defect inspection of internal defects and front and rear surface defects in the wafer.

Incidentally, if a wafer has defects, such as grinding marks or adherent foreign matter, on the front and/or rear surface thereof, irradiated infrared light reflects off the defects in the front and/or rear surface and appears as a defect image in a transmitted image. Thus, it is difficult to extract internal defects alone. In contrast, according to the first aspect, it is possible to extract only internal defects existent within the wafer, such as pinholes, cracks and voids, from the transmitted image by removing defect images corresponding to defects appearing in the reflected images of both surfaces from a defect image appearing in the transmitted image.

In addition, in the first aspect, it is possible to extract defects in the wafer on the basis of reflected images and transmitted images of both surfaces by successively irradiating infrared light from both surfaces of the wafer under inspection and taking the transmitted images of both surfaces and reflected images of both surfaces. For example, if there is any penetrating defect penetrating from the front surface to the rear surface of the wafer, this penetrating defect appears in all of the reflected images and the transmitted images of both surfaces. Thus, it is possible to detect the penetrating defect in distinction from other defects.

On the other hand, a second aspect of the method for inspecting defects in a wafer according to the present invention irradiates infrared light from a light source/image pickup unit disposed at one surface of a wafer to the wafer, so that infrared light having transmitted through the wafer is received by an image pickup unit disposed at the other surface of the wafer to take a transmitted image of the wafer, and then takes another transmitted image of the wafer with the amount of infrared light to be received by the image pickup unit made larger, and irradiates infrared light or visible light from the light source/image pickup unit to take a reflected image of the wafer by the light source/image pickup unit, thereby extracting defects in the wafer by means of image processing based on these transmitted and reflected images.

That is, if the transmitted image is taken with the amount of light made larger, front and rear surface defects are less likely to appear in the transmitted image, thereby making only internal defects distinct. Therefore, it is possible to detect internal defects with the transmitted image alone. In addition, images of internal defects and defects in one surface detected in the reflected image are removed from a transmitted image taken with the amount of infrared light made smaller, so that front and rear surface defects and internal defects in the wafer appear. Consequently, it is possible to extract defects in the other surface of the wafer. As a result, it is possible to simultaneously detect both internal defects and front and rear surface defects in the wafer. Furthermore, since the light source/image pickup unit and the image pickup unit are disposed oppositely to each other across the wafer, so that the light source/image pickup unit and the image pickup unit for taking the transmitted image and the reflected image are adapted for common use, it is possible to reduce time and effort involved in, for example, flipping over the wafer or moving the light source/image pickup unit. Consequently, it is possible to improve work efficiency in the defect inspection of a wafer.

In addition, a third aspect of the method for inspecting defects in a wafer according to the present invention takes a transmitted image of a wafer under inspection on the basis of the set intensity of infrared light and the set exposure time of an imaging device, and evaluates the luminance frequency distribution of respective pixels of the taken transmitted image, thereby inspecting defects in the wafer by means of image processing including a determination step of determining that an internal defect exists if the evaluated luminance distribution has two peaks.

That is, the inventors et al. of the present invention have learned that if a transmitted image is taken with such an intensity of infrared light or a exposure time of the image pickup device as to make defects in both surfaces of the wafer negligible, two peaks appear in the luminance frequency distribution of pixels of the transmitted image in the case of a wafer having an internal defect. According to this phenomenon, if two peaks appear in the luminance frequency distribution of pixels of the transmitted image while the intensity of infrared light and/or the exposure time of the image pickup device is gradually increased, it is possible to determine that an internal defect exists in the wafer. Consequently, it is possible to detect internal defects in the wafer with the transmitted image of the wafer alone. Thus, it is possible to reduce time and effort involved in taking reflected images of the wafer. As a result, it is possible to improve work efficiency in defect inspection. Note that an internal defect appears on the high-luminance side, while front and rear surface defects appear on the low-luminance side. Accordingly, if the high-luminance side is cut off, it is possible to extract data on front and rear surface defects in the wafer. In this case, it is not possible to separate the front surface defect and the rear surface defect in the wafer from each other.

On the other hand, the method for inspecting defects in a wafer according to the first aspect of the present invention can be embodied by an apparatus including: an inspection bench for supporting the peripheral part of a wafer; a first light source/image pickup unit configured by attaching a first light source for switching between infrared light and visible light to irradiate the light to one surface of the wafer and a first image pickup device for taking an image of the one surface to the same optical system; a second light source/image pickup unit configured by attaching a second light source for switching between infrared light and visible light to irradiate the light to the other surface of the wafer and a second image pickup device for taking an image of the other surface to the same optical system; and defect image generating means for generating a defect image of the wafer on the basis of a transmitted image taken by controlling the first and second light sources and the first and second image pickup devices and receiving the transmitted light of infrared light irradiated from the second light source to the other surface of the wafer with the first image pickup device, a first reflected image taken by receiving the reflected light of infrared light or visible light irradiated from the first light source to one surface of the wafer with the first image pickup device, and a second reflected image taken by receiving the reflected light of infrared light or visible light irradiated from the second light source to the other surface of the wafer with the second image pickup device.

In this case, the defect image of the wafer can be generated on the basis of the first transmitted image, the second transmitted image taken with the amount of light made larger than when the first transmitted image is taken, and the reflected image of one surface of the wafer.

In addition, the method for inspecting defects in a wafer according to the third aspect of the present invention can be embodied by an apparatus including: an inspection bench for supporting the peripheral part of a wafer; a light source for irradiating infrared light to one surface of the wafer; an image pickup device for taking a transmitted image by receiving the transmitted light of infrared light irradiated from the light source to the wafer; and defect image generating means for generating a defect image of the wafer on the basis of the transmitted image taken by the image pickup device, wherein the defect image generating means takes a transmitted image of the wafer under inspection on the basis of the set intensity of infrared light and the set exposure time of an imaging device, evaluates the luminance frequency distribution of respective pixels of the taken transmitted image, and determines that an internal defect exists in the wafer if the evaluated luminance frequency distribution has two peaks, thereby generating the defect image.

According to the present invention, it is possible to simultaneously detect both internal defects and front and rear surface defects in the wafer and improve work efficiency in defect inspection.

### BRIEF DESCRIPTION OF THE DRAWINGS

FIG. 1 is an overall configuration diagram of a defect inspection apparatus of embodiment 1;

FIG. 2 is a drawing showing a flowchart of a defect inspection method of embodiment 1;

FIG. 3 is a drawing showing the differential image processing of embodiment 1;

FIG. 4 is a drawing showing a flowchart of a defect inspection method of embodiment 2;

FIG. 5 is a drawing showing the differential image processing of embodiment 2;

FIG. 6 is a drawing showing transmitted images taken with the amount of light varied;

FIG. 7 is an overall configuration diagram of a defect inspection apparatus of embodiment 3;

FIG. 8 is a drawing showing a luminance distribution of a transmitted image;

FIG. 9 is a drawing showing a flowchart of the defect inspection method of embodiment 3; and

FIG. 10 is a drawing showing a relationship between the impurity concentration (specific resistance) of a wafer and the transmittance of infrared rays.

### DETAILED DESCRIPTION OF THE INVENTION

Hereinafter, a defect inspection apparatus for directly carrying out a method for inspecting defects in a wafer according to the present invention will be described based on embodiments thereof.

### Embodiment 1

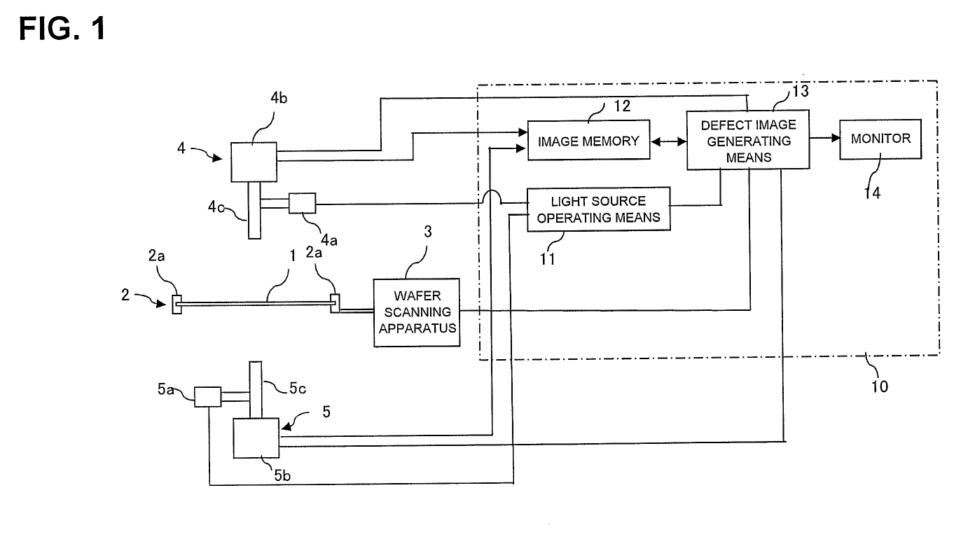

FIG. 1 shows an overall configuration diagram of a defect inspection apparatus according to embodiment 1 of the present invention. As shown in the figure, a wafer 1 under inspection is supported by an inspection bench 2 including a frame 2a for supporting plural places of a peripheral part of the wafer. In embodiment 1, the inspection bench 2 is formed so as to be movable back and forth and right and left along a surface of the wafer 1 by a wafer scanning apparatus 3. A first light source/image pickup unit 4 is arranged oppositely to one surface of the wafer (hereinafter referred to as the front surface). The first light source/image pickup unit 4 is formed by attaching a first light source 4a for irradiating infrared light and visible light while switching therebetween and a first image pickup device 4b for taking an image of the front surface to the same telecentric optical system 4c including lenses and the like. In addition, a second light source/image pickup unit 5 is arranged oppositely to the other surface of the wafer 1 (hereinafter referred to as the rear surface). The second light source/image pickup unit 5 is formed by attaching a second light source 5a for irradiating infrared light and visible light while switching therebetween and a second image pickup device 5b for taking an image of the rear surface to the same telecentric optical system 5c including lenses and the like. With this arrangement, the optical axes of the two light source/image pickup units 4 and 5 are made to agree with each other. Here, the telecentric optical systems 4c and 5c are, as is commonly known, optical devices whose magnifications do not change even if the focal points thereof vary. Unillustrated half mirrors are provided within the telecentric optical systems 4c and 5c. The half mirrors reflect infrared light (or visible light) from the light sources 4a and 5a to irradiate the light to the front and rear surfaces of the wafer 1. In addition, the half mirrors are configured to allow infrared light (or visible light) from the wafer 1 to transmit therethrough and guide the light to the image pickup devices 4b and 5b.

On the other hand, a defect image generating apparatus 10 is configured by including light source operating means 11 for turning on/off the first and second light sources 4a and 5a and switching between infrared light and visible light as necessary. In addition, the defect image generating apparatus 10 is configured by including an image memory 12 for storing images taken by the first and second image pickup devices 4b and 5b. Furthermore, the defect image generating apparatus 10 is configured by including defect image generating means 13 and a monitor 14 for displaying images. The defect image generating means 13 controls the operation of the wafer scanning apparatus 3 and the light source operating means 11, and performs control whereby to store images taken by the first and second image pickup devices 4b and 5b in the image memory 12.

In addition, the defect image generating means 13 stores a first reflected image A taken by receiving the reflected light of infrared light (or visible light) irradiated from the first light source 4a to the front surface of the wafer 1 with the first image pickup device 4b in the image memory 12. Likewise, the defect image generating means 13 stores a transmitted image B taken by receiving the transmitted light of infrared light irradiated from the second light source 5a to the rear surface of the wafer 1 with the first image pickup device 4b in the image memory 12. Still likewise, the defect image generating means 13 stores a second reflected image C taken by receiving the reflected light of infrared light (or visible light) irradiated from the second light source 5a to the rear surface of the wafer 1 with the second image pickup device 5b in the image memory 12. Then, the defect image generating means 13 generates a defect image of the wafer 1 by means of differential image processing to be described later to display the defect image on the monitor 14, and stores the image in the image memory 12.

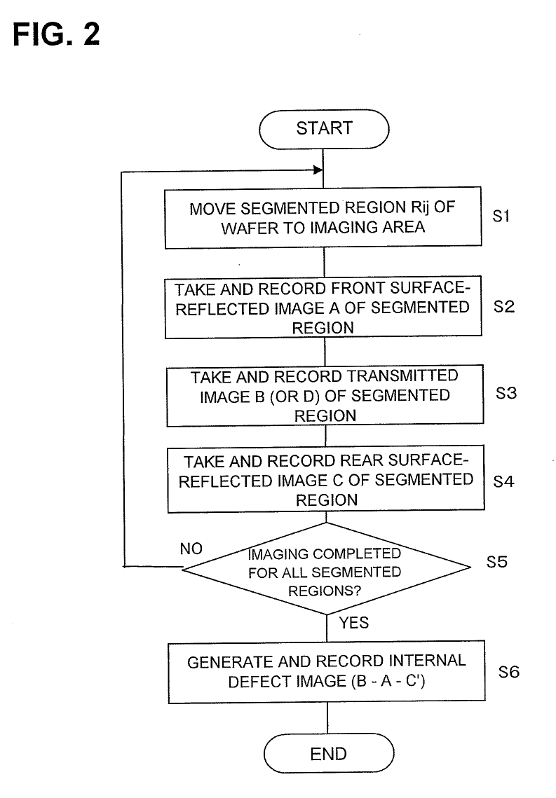

Here, one example of a processing procedure taken by the defect image generating means 13 will be described with reference to the flowchart shown in FIG. 2. This example shows a case in which the size (diameter) of the wafer 1 is larger than the size of the imaging visual field of the first and second light source/image pickup units 4 and 5, and therefore, it is not possible to take an image of the entire surface of the wafer 1 with one time of imaging operation. In this case, the front and rear surfaces of the wafer 1 are divided into a plurality of segmented regions Rij (where i, j=0, 1, . . . , n) along orthogonal two axes (X, Y), according to the size of the imaging visual field of the light source/image pickup units 4 and 5. The way of dividing the segmented regions Rij is optional. For example, if the imaging visual field of the light source/image pickup units 4 and 5 is circular, the units are set so that all of the segmented regions Rij fall within the imaging visual field by scanning.

The defect image generating means 13 drives the wafer scanning apparatus 3 in accordance with the set segmented regions Rij and moves the wafer 1, so that a first segmented region R₀₀ falls within the imaging visual field (S1). Next, the defect image generating means 13 operates the light source operating means 11 to irradiate infrared light (or visible light) from the light source 4a to the front surface of the wafer 1, and the reflected light of the infrared light (or visible light) is received with the image pickup device 4b to take a first reflected image A₀₀ and store the image in the image memory 12 (S2). In addition, the defect image generating means 13 operates the light source operating means 11 to irradiate infrared light from the light source 5a to the rear surface of the wafer 1, and the transmitted light of the infrared light is received with the image pickup device 4b to take a transmitted image B₀₀ and store the image in the image memory 12 (S3). Furthermore, infrared light (or visible light) is irradiated from the second light source 5a to the rear surface of the wafer 1, and the reflected light of the infrared light (or visible light) is received with the image pickup device 5b to take a second reflected image C₀₀ and store the image in the image memory 12 (S4). Note that the order of steps S2 to S4 is not limited to this but the steps may be carried out in any order.

When capture of the first reflected image A₀₀, transmitted image B₀₀, and reflected image C₀₀ of the first segmented region Rij is completed in this way, the defect image generating means 13 determines whether or not imaging of all of the segmented regions is completed (S5). If a determination is made that there are not-yet-imaged segmented regions Rij, the defect image generating means 13 goes back to S1, moves the next segmented region Rij to the imaging visual field, and repeatedly executes S1 to S5. When capture of reflected images Aij, transmitted images Bij, and reflected images Cij is completed for all of the segmented regions Rij, the defect image generating means 13 generates a defect image of the wafer 1 on the basis of those images stored in the image memory 12 (S6).

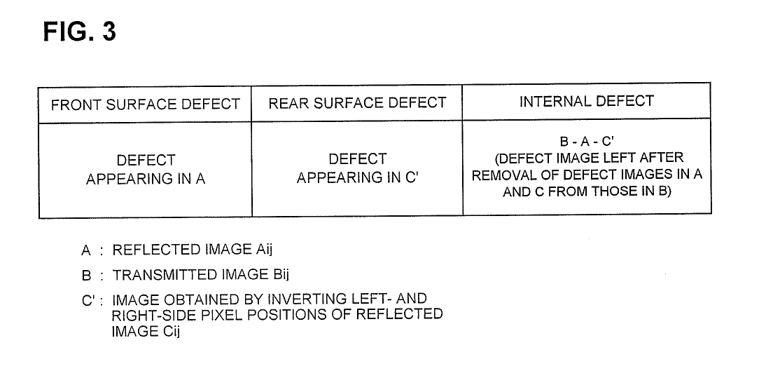

The defect image to be generated is determined as described below, by means of differential image processing shown in FIG. 3. Symbol A in the figure denotes the reflected image Aij, symbol B denotes the transmitted image Bij, and symbol C′ denotes an image obtained by inverting the left- and right-side pixel positions of the reflected image Cij, so that the reflected image Cij corresponds to the transmitted image Bij. As shown in the figure, a front or rear surface defect in the wafer 1 appears as a difference in luminance in the first reflected image A or the second reflected image C′. Therefore, it is possible to determine front and rear surface defects in the wafer 1 by extracting the pixels of this defect. In addition, front and rear surface defects in the wafer 1 may in some cases appear in the transmitted image B. Accordingly, there is performed differential image processing for removing images of defects appearing in the first reflected image A and the second reflected image C′ from shades appearing in the transmitted image B. Then, by extracting pixels indicative of defects remaining in the transmitted image B, it is possible to detect only internal defects in the wafer 1.

According to this method, it is possible to simultaneously take both the transmitted image Bij of the wafer 1 and the reflected images Aij and Cij of both surfaces thereof with the two light source/image pickup units 4 and 5 disposed oppositely to each other across the wafer 1. Consequently, it is possible to simultaneously detect both internal defects and front and rear surface defects in the wafer 1. In addition, since the transmitted image Bij in the wafer 1 and the reflected images Aij and Cij of both surfaces thereof can be taken with the light source/image pickup units 4 and 5 for common use, it is possible to reduce time and effort involved in flipping over the wafer 1 or moving the light source/image pickup units 4 and 5. As a result, it is possible to improve work efficiency in defect inspection.

Even in cases where defects exist in the front and rear surfaces of the wafer 1 and the defects in the front and rear surfaces of the wafer 1 appear in the transmitted image Bij, it is possible to extract only internal defects in the wafer by means of differential image processing based on the transmitted image Bij and the reflected images Aij and Cij of both surfaces. As a result, it is possible to distinguish the internal defects from, for example, defects due to removable foreign matter adhering to the surfaces of the wafer 1 and tolerable grinding marks in the wafer 1. Therefore, it is possible to improve the yield of the wafer 1 by distinguishing the internal defects from the front and rear surface defects.

In addition, it is possible to take a transmitted image Dij, in addition to the transmitted image Bij, by receiving the transmitted light of infrared light irradiated from the light source 4a to the front surface of the wafer 1 with the image pickup device 5b, store the transmitted image Dij in the image memory 12, and generate a defect image of the wafer 1 on the basis of the reflected image Aij, transmitted image Bij, reflected image Cij, and transmitted image Dij of the wafer 1. According to this method, it is possible to distinctly detect a penetrating defect, since the penetrating defect appears as a common defect in all of the reflected image Aij, the transmitted image Bij, the reflected image cij, and the transmitted image Dij if there is any penetrating defect penetrating from the front surface to the rear surface of the wafer 1.

Note that in the processing procedure of FIG. 2, an example has been shown in which the entire wafer 1 is scanned across the imaging visual field of the light source/image pickup units 4 and 5 by moving the wafer 1 along a surface thereof by the wafer scanning apparatus 3 with respect to the imaging visual field of the first and second light source/image pickup units 4 and 5. However, the present invention is not limited to this. That is, the imaging visual field of the light source/image pickup units 4 and 5 and the entire surface of the wafer 1 may be scanned relative to each other. For example, the entire surface of the wafer 1 can be scanned by fixing the wafer 1 to the inspection bench 2 and moving the light source/image pickup units 4 and 5 along a wafer surface.

Furthermore, even in cases where the light source/image pickup units 4 and 5 are scanned along a wafer surface, it is possible to arrange the respective light source/image pickup units 4 and 5 plurally in rows and move and scan the entirety of the plurality of the light source/image pickup units 4 and 5 in one direction (for example, in an anteroposterior direction in FIG. 1) with respect to the wafer 1. According to this method, it is possible to increase the resolution of images and reduce an inspection time involved in scanning. Note that if the imaging visual field of the light source/image pickup units 4 and 5 is sufficiently larger than the size (diameter) of the wafer 1, the wafer 1 need not be scanned.

In addition, switching between infrared light and visible light in the light source 4a and the light source 5a can be achieved by selecting, as appropriate, from such methods as switching light generated from one light source to infrared light or visible light by a polarization filter or arranging separate sources of infrared light and visible light and switching between optical paths.

In addition, since visible light does not transmit through the wafer 1, taking the reflected image Aij and reflected image Cij of the wafer 1 by using the reflected light of visible light makes it possible to simultaneously obtain both the reflected image Aij and the reflected image Cij by the image pickup devices 4b and 5b. As a result, it is possible to further reduce a working time taken in the defect inspection of the wafer 1.

### Embodiment 2

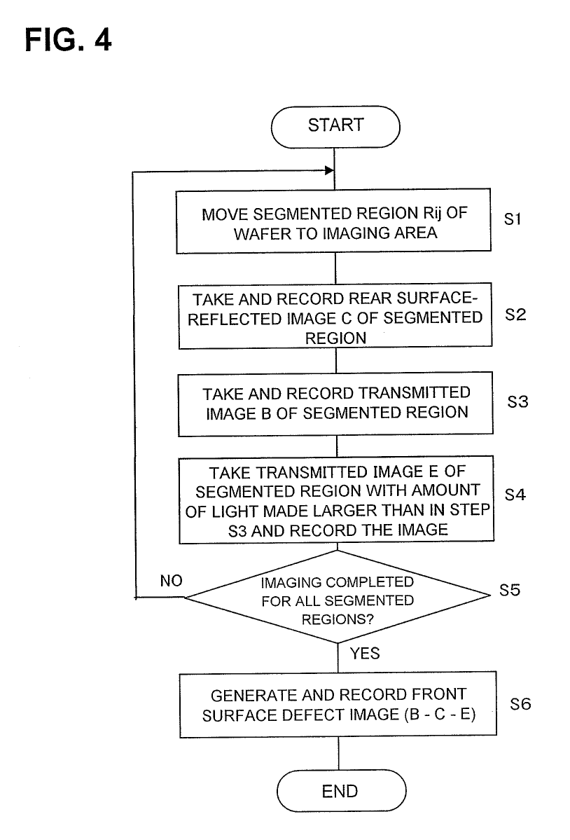

FIG. 4 shows a flowchart of a defect inspecting method according to embodiment 2 of the present invention. Embodiment 2 differs from embodiment 1 in that the reflected image Aij is not taken, the transmitted image Eij is taken with the amount of light made larger than when the transmitted image Bij is taken, and a defect image is generated on the basis of the reflected image Cij, transmitted image Bij and transmitted image Eij. The defect inspection apparatus is the same, except the defect image generating means 13, as that of embodiment 1, and therefore, will not be explained again.

The defect image generating means 13 drives the wafer scanning apparatus 3 in accordance with the set segmented regions Rij and moves the wafer 1, so that a first segmented region R₀₀ falls within the imaging visual field (S1). Next, the defect image generating means 13 operates the light source operating means 11 to irradiate infrared light (or visible light) from the light source 5a to the rear surface of the wafer 1, and the reflected light of the infrared light (or visible light) is received with the image pickup device 5b to take a reflected image C₀₀ and store the image in the image memory 12 (S2). In addition, the defect image generating means 13 operates the light source operating means 11 to irradiate infrared light from the light source 5a to the rear surface of the wafer 1, and the transmitted light of the infrared light is received with the image pickup device 4b to take a first transmitted image B₀₀ and store the image in the image memory 12 (S3). Furthermore, the defect image generating means 13 raises the luminance of infrared light irradiated from the light source 5a or lengthens the exposure time of the image pickup device 4b to take a second transmitted image E₀₀ with the amount of transmitted light received by the image pickup device 4b made larger, and stores the image in the image memory 12 (S4). Note that the order of steps S2 to S4 is not limited to this but the steps may be carried out in any order.

When capture of the reflected image C₀₀, first transmitted image B₀₀, and second transmitted image E₀₀ of the first segmented region Rij is completed in this way, the defect image generating means 13 determines whether or not imaging of all of the segmented regions is completed (S5). If a determination is made that there are not-yet-imaged segmented regions Rij, the defect image generating means 13 goes back to S1, moves the next segmented region Rij to the imaging visual field, and repeatedly executes S1 to S5. When capture of the reflected images Cij, transmitted images Bij, and transmitted images Eij is completed for all of the segmented regions Rij, the defect image generating means 13 generates a defect image of the wafer 1 on the basis of those images stored in the image memory 12 (S6).

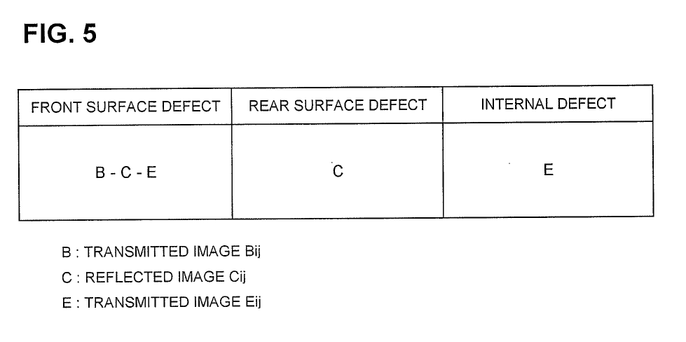

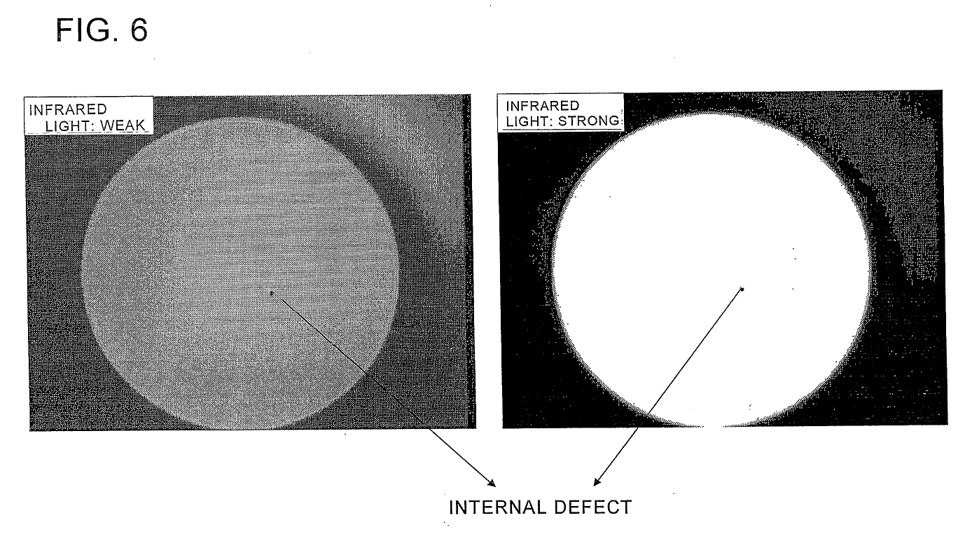

The defect image to be generated is determined as described below, by means of differential image processing shown in FIG. 5. Symbol B in FIG. 5 denotes the first transmitted image Bij, symbol C denotes the reflected image Cij, and symbol E denotes the second transmitted image Eij. As shown in the figure, a rear surface defect in the wafer 1 appears as a shade in the reflected image C. Therefore, it is possible to detect the rear surface defect by extracting the pixels of the defect. In addition, as shown in FIG. 6, only the internal defect distinctly appears in the second transmitted image E taken with the amount of light made larger. Therefore, it is possible to detect the internal defect by extracting the pixels of the defect. Furthermore, the front and rear surface defects and the internal defect in the wafer 1 appear in the first transmitted image B. Accordingly, there is performed differential image processing for removing images of defects appearing in the first transmitted image B from images of defects appearing in the reflected image C and the second transmitted image E to extract pixels of defects remaining in the transmitted image B. Consequently, it is possible to distinctly detect the front surface defects in the wafer 1. In addition, it is possible to distinctly detect a defect appearing in common in the reflected image C and in the first transmitted image B and the second transmitted image E as a penetrating defect.

According to this method, it is possible to simultaneously detect both the internal defect and the front and rear surface defects in the wafer 1 by using the taken transmitted images Bij and Eij and reflected image Cij. In addition, since the transmitted images Bij and Eij and the reflected image Cij can be taken by a pair of the light source/image pickup units 4 and 5, it is possible to detect the internal defect and the front and rear surface defects in the wafer 1 with the light source/image pickup units 4 and 5 adapted for common use. As a result, it is possible to improve work efficiency in the defect inspection of the wafer 1 since defect inspection can be performed with one unit of defect inspection apparatus. Furthermore, it is possible to improve the yield of the wafer 1 since the internal defect, the front and rear surface defects, and the penetrating defect in the wafer 1 can be detected in distinction from one another.

Note that the apparatus of embodiment 2 may be a defect inspection apparatus capable of irradiating at least infrared light from one surface of the wafer 1. Thus, either one of the light source/image pickup units 4 and 5 can be used as an image pickup unit equipped with an image pickup device and an optical system.

### Embodiment 3

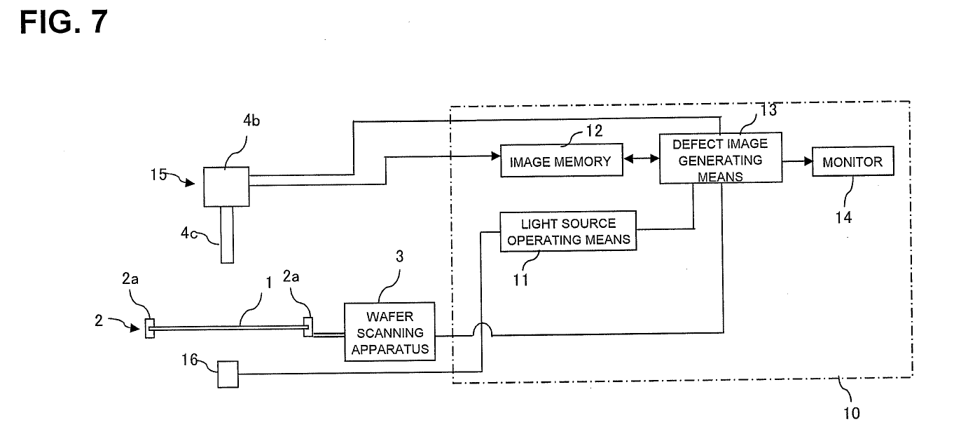

FIG. 7 shows an overall configuration diagram of a defect inspection apparatus according to embodiment 3 of the present invention. Embodiment 3 differs from embodiment 1 in that an image pickup unit 15 equipped with an image pickup device 4b and an optical system 4c is disposed at one surface of the wafer 1 in place of the light source/image pickup units 4 and 5, and an optical unit 16 equipped with an unillustrated light source and optical system is disposed at the other surface of the wafer 1, so that the optical axes of the image pickup unit 15 and the optical unit 16 agree with each other. Another difference is that the defect image generating means 13 includes judgment data indicative of the luminance range of pixels corresponding to an internal defect in the wafer 1. The rest of configuration is the same as that of embodiment 1, and therefore, like components are denoted by like reference characters and will not be explained again.

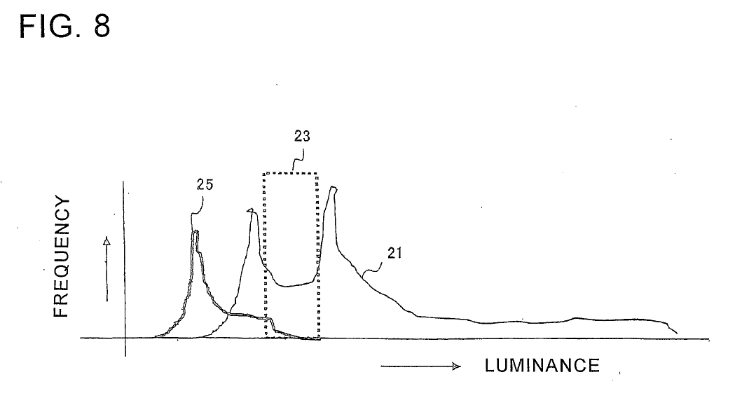

The principles of defect inspection in the present embodiment 3 will be described using FIG. 8. FIG. 8 is a graphical view showing the luminance frequency distribution of respective pixels of a transmitted image of a wafer taken by irradiating infrared rays, where the axis of abscissas represents luminance and the axis of ordinates represents the frequency at which pixels having the same luminance are detected. The frequency distribution curve denoted by a solid line 25 in the figure represents an example of a transmitted image for a relatively low intensity of infrared rays. Thus, the frequency distribution results in a curve having one vertex (peak). However, the inventors have learned that the frequency distribution in some cases results in such a curve having two peaks as represented by a solid line 21 as the intensity of infrared rays is made higher or the exposure time of the image pickup device is made longer. The inventors have also learned that the positions of the two peaks and the maximum values (frequencies) in the frequency distribution vary, depending on the intensity of infrared rays or the exposure time of the image pickup device.

The reason for the two peaks appearing in the luminance frequency distribution, as shown by the solid line 21, is considered to be that transmittance decreases since an internal defect exists in a location corresponding to pixels within a peak-to-peak luminance range (region enclosed by a dotted line 23) and infrared rays reflect off the internal defect. Hence, a wafer for which a transmitted image having a two-peak luminance frequency distribution was obtained was actually cut and an observation was made of the inside of the wafer. This observation proved the existence of the internal defect. From this finding, it is understood that if such two peaks as shown by the solid line 21 appear when a transmitted image of the wafer is taken as the intensity of infrared rays is made higher or the exposure time is made longer, it is possible to detect that the internal defect exists in the wafer.

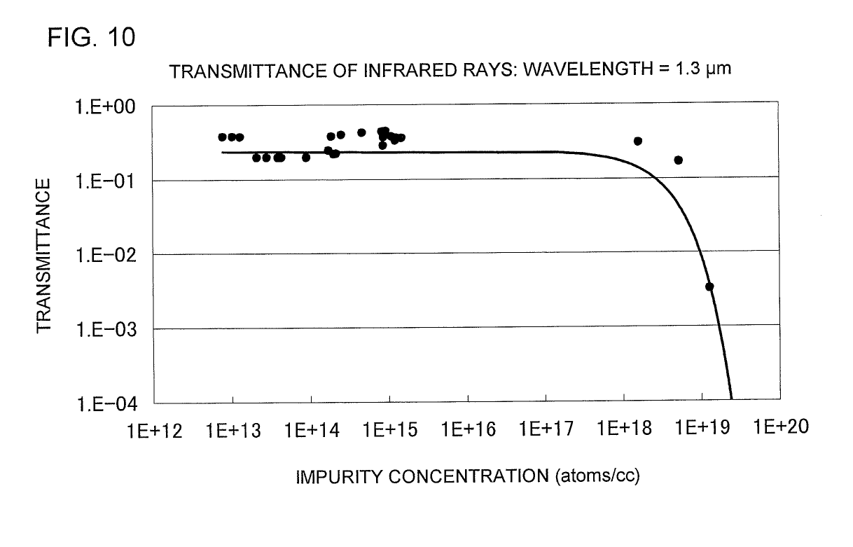

A further study was made of the phenomenon shown in FIG. 8. In a single-crystal silicon wafer, the transmission behavior of infrared rays varies depending on the impurity concentration (specific resistance: Ω·cm) of the wafer. Accordingly, as shown in FIG. 10, it becomes increasingly difficult for infrared rays to transmit through as the impurity concentration increases. The axis of abscissas of FIG. 10 represents the impurity concentration (atoms/cc) and the axis of ordinates represents the transmittance of infrared rays. In addition, data shown in the figure was measured by setting the wavelength of infrared rays to 1.3 μm. From this finding, the intensity of infrared rays is preferably controlled so that transmission intensity remains the same according to the specific resistance of the wafer. In this case, the intensity of transmitted light is measured at the center position of the wafer prior to defect inspection to control the intensity of infrared rays of the light source, so that the luminance of a transmitted image is kept constant.

That is, the set intensity of infrared light and the set exposure time of the image pickup device are previously determined according to the specific resistance of a wafer to be inspected, and the intensity of infrared light and the exposure time of the image pickup device are set in accordance with the target wafer at the time of inspection. Then, a transmitted image of the wafer 1 is taken at the set intensity of infrared light and the set exposure time of the image pickup device to determine the luminance distribution of the transmitted image. If such a two-peak luminance distribution pattern as shown by the solid line 21 in FIG. 8 is consequently obtained, it is possible to determine that an internal defect exists in the wafer 1.

Note that it is predicted that the luminance frequency of the region enclosed by the dotted line 23 in FIG. 8 varies, depending on the specific resistance of the wafer, the intensity of infrared light, and the exposure time of the image pickup device. Accordingly, it is preferable to store previously prepared judgment data in the defect image generating means 13. That is, a transmitted image of a wafer having defects is previously taken at the set intensity of infrared light and the set exposure time of the image pickup device at which defects in both surfaces of the wafer are negligible. Then, the luminous frequency distribution of respective pixels of this transmitted image is determined, the luminance range of pixels corresponding to an internal defect in the wafer is determined on the basis of this frequency distribution, and judgment data is created.

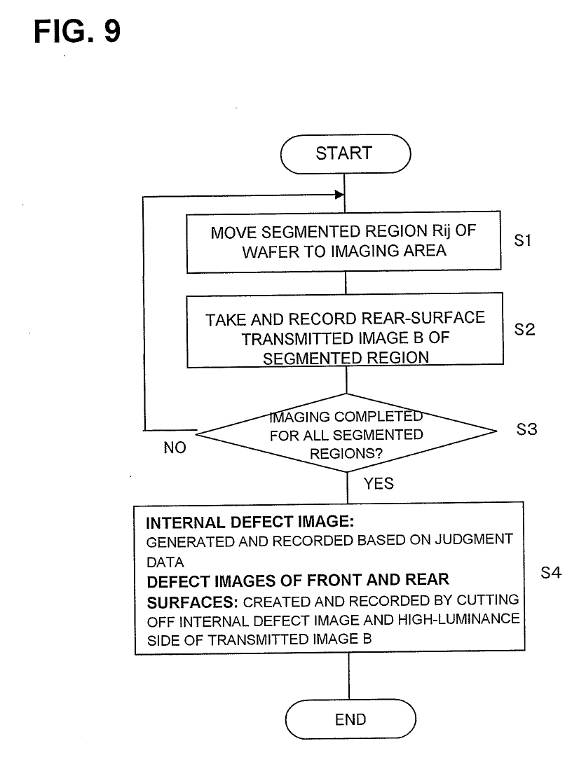

FIG. 9 shows a flowchart of a defect inspection method of embodiment 3. The defect image generating means 13 drives the wafer scanning apparatus in accordance with the set segmented regions Rij to move the wafer 1, so that a first segmented region R₀₀ falls within the imaging visual field (S1). Next, the defect image generating means 13 operates the light source operating means 11 to irradiate infrared light from the light source unit 16 to the rear surface of the wafer 1, thereby taking a transmitted image B₀₀ with the image pickup unit 15 according to the intensity of infrared light and the exposure time of the image pickup device at which the judgment data has been previously determined, and storing the image in the image memory 12 (S2). When capture of the transmitted image B₀₀ of the first segmented region R₀₀ is completed, the defect image generating means 13 determines whether or not imaging of all of the segmented regions is completed (S3). If a determination is made that there are not-yet-imaged segmented regions Rij, the defect image generating means 13 goes back to S1, moves the next segmented region Rij to the imaging visual field, and repeatedly executes S1 and S2. When capture of transmitted images Bij is completed for all of the segmented regions Rij, the defect image generating means 13 compares the luminance of respective pixels of those images stored in the image memory 12 with the judgment data. Then, the defect image generating means 13 extracts pixels within the luminance range corresponding to the internal defect from the transmitted image Bij to generate and record an internal defect image of the wafer 1 (S4).

In addition, pixels of the transmitted image Bij indicative of luminance other than that of the internal defect include information on low luminance levels corresponding to front and rear surface defects. Hence, by cutting off the high-luminance side and extracting data on the front and rear surface defects, it is possible to create and record images of the front and rear surface defects.

According to this method, it is possible to detect an internal defect in the wafer 1 with the transmitted image Bij of the wafer 1 alone. Consequently, it is possible to reduce time and effort involved in taking reflected images of the wafer 1. As a result, it is possible to improve work efficiency in defect inspection.

Note that the luminance range of judgment data can be determined prior to defect inspection by measuring the data as appropriate. For example, when the intensity of infrared light was set to 2000 cd and the exposure time of the image pickup device was set to 100 ms in a case where the specific resistance of the wafer was 1 Ω·cm, the luminance range of judgment data was 400 cd/m² to 600 cd/m².

In the present embodiment 3, it is also possible to apply a configuration in which light source/image pickup units including a light source, an image pickup device and an optical system are disposed at both surfaces of the wafer 1 to irradiate infrared light or visible light to both surfaces of the wafer 1 and take reflected images of the front and rear surfaces of the wafer 1, thereby detecting front and rear surface defects in the wafer 1 on the basis of the taken reflected images of both surfaces.

### DESCRIPTION OF SYMBOLS

1 Wafer
4 Light source/image pickup unit
4a Light source
4b Image pickup device
5 Light source/image pickup unit
5a Light source
5b Image pickup device
10 Defect image generating apparatus
13 Defect image generating means
15 Image pickup unit
16 Light source unit

1. A defect inspection method for inspecting defects in a wafer by irradiating light to a wafer to take at least one of a transmitted image and a reflected image of the wafer and image-processing the taken image to inspect defects in the wafer, including internal defects.

2. The defect inspection method according to claim 1, comprising:
a first imaging procedure in which a transmitted image of the wafer is taken by disposing two light source/image pickup units equipped with a light source, an image pickup device and an optical system oppositely to each other across the wafer, irradiating infrared light from at least one of the light source/image pickup units to the wafer, and receiving transmitted light from the wafer with the other light source/image pickup unit; and
a second imaging procedure in which the respective reflected images of both surfaces of the wafer are taken by irradiating infrared light or visible light from the light source/image pickup units to the wafer and receiving reflected light from the wafer with the light source/image pickup units,
wherein the image processing includes an extraction procedure in which the defects in the wafer are extracted on the basis of the transmitted image and the reflected images of both surfaces of the wafer.

3. The defect inspection method according to claim 2,
wherein the first imaging procedure irradiates infrared light from both surfaces of the wafer to take respective transmitted images of both surfaces of the wafer, and the extraction procedure extracts defects in the wafer on the basis of the transmitted images of both surfaces and the reflected images of both surfaces of the wafer.

4. The defect inspection method according to claim 1, comprising:
a first imaging procedure in which a transmitted image of the wafer is taken by disposing a light source/image pickup unit equipped with a light source, an image pickup device and an optical system and an image pickup unit equipped with an image pickup device and an optical system oppositely to each other across the wafer, irradiating infrared light from the light source/image pickup unit to the wafer, and receiving transmitted light from the wafer with the image pickup unit;
a second imaging procedure in which a transmitted image of the wafer is taken by adjusting the intensity of infrared light to be irradiated from the light source of the light source/image pickup unit or the exposure time of the image pickup device of the image pickup unit to make the amount of the infrared light larger than in the first imaging procedure; and
a third imaging procedure in which a reflected image is taken by irradiating infrared light or visible light from the light source/image pickup unit to the wafer and receiving reflected light from the wafer with the light source/image pickup unit,
wherein the image processing includes extracting defects in the wafer on the basis of the transmitted images obtained in the first and second imaging procedures and the reflected image obtained in the third imaging procedure.

5. The defect inspection method according to claim 1, further comprising:
an imaging procedure in which a transmitted image of the wafer under inspection is taken on the basis of the set intensity of infrared light and the set exposure time of an imaging device,
wherein the image processing includes evaluating the luminance frequency distribution of respective pixels of the transmitted image obtained in the imaging step procedure and determining that an internal defect exists in the wafer if the evaluated luminance distribution has two peaks.

6. An apparatus for inspecting defects in a wafer, comprising:
an inspection bench for supporting the peripheral part of a wafer;
a first light source/image pickup unit configured by attaching a first light source for switching between infrared light and visible light to irradiate the light to one surface of the wafer and a first image pickup device for taking an image of the one surface to the same optical system;
a second light source/image pickup unit configured by attaching a second light source for switching between infrared light and visible light to irradiate the light to the other surface of the wafer and a second image pickup device for taking an image of the other surface to the same optical system; and
a defect image generator that generates a defect image of the wafer on the basis of a transmitted image taken by controlling the first and second light sources and the first and second image pickup devices and receiving the transmitted light of infrared light irradiated from the second light source to the other surface of the wafer with the first image pickup device, a first reflected image taken by receiving the reflected light of infrared light or visible light irradiated from the first light source to one surface of the wafer with the first image pickup device, and a second reflected image taken by receiving the reflected light of infrared light or visible light irradiated from the second light source to the other surface of the wafer with the second image pickup device.

7. The apparatus for inspecting defects in a wafer according to claim 6,
wherein the defect image generator generates the defect image of the wafer on the basis of a first transmitted image taken with a first amount of light by controlling the first and second light sources and the first and second image pickup devices and receiving the transmitted light of infrared light irradiated from the second light source to the other surface of the wafer with the first image pickup device, a second transmitted image taken with a second amount of light larger than the first amount of light by receiving the transmitted light of infrared light irradiated from the second light source to the other surface of the wafer with the first image pickup device, and a second reflected image taken by receiving the reflected light of infrared light or visible light irradiated from the second light source to the other surface of the wafer with the second image pickup device.

8. An apparatus for inspecting defects in a wafer, comprising:
an inspection bench for supporting the peripheral part of a wafer;
a light source for irradiating infrared light to one surface of the wafer;
an image pickup device for taking a transmitted image by receiving the transmitted light of infrared light irradiated from the light source to the wafer; and
a defect image generator that generates a defect image of the wafer on the basis of the transmitted image taken by the image pickup device,
wherein the defect image generator takes a transmitted image of the wafer under inspection on the basis of the set intensity of infrared light and the set exposure time of an imaging device, evaluates the luminance frequency distribution of respective pixels of the taken transmitted image, and determines that an internal defect exists in the wafer if the evaluated luminance frequency distribution has two peaks, thereby generating the defect image.
